(19) United States
(12) Patent Application Publication
(10) Pub. No.: US 2026/0086931 A1
(43) Pub. Date: Mar. 26, 2026

(54) MEMORY SYSTEM, STORAGE APPARATUS, AND CONTROL METHOD

(71) Applicant: Kioxia Corporation, Tokyo (JP)

(72) Inventor: Daisuke NAKATA, Chigasaki (JP)

(73) Assignee: Kioxia Corporation, Tokyo (JP)

(21) Appl. No.: 19/074,874

(22) Filed: Mar. 10, 2025

(30) Foreign Application Priority Data
Sep. 20, 2024 (JP) 2024-163892

(51) Int. Cl. G06F 12/02

(52) U.S. Cl. CPC G06F 12/0223

(57) ABSTRACT

A memory system includes a non-volatile memory and a controller. The controller includes an instruction information processing unit configured to generate internal instruction information for causing the non-volatile memory to execute an instruction that causes the non-volatile memory to read and write the data based on external instruction information including the instruction and configured to transmit the internal instruction information to the non-volatile memory through the memory interface circuit, and a delay circuit control unit configured to control a delay circuit based on a magnitude relationship between a data amount read and written by the non-volatile memory during unit time and a first threshold value. The delay circuit is configured to delay execution of the instruction.

### CROSS-REFERENCE TO RELATED APPLICATION

This application is based upon and claims the benefit of priority from Japanese Patent Application No. 2024-163892, filed on Sep. 20, 2024, the entire contents of which are incorporated herein by reference.

### BACKGROUND OF THE INVENTION

### Field of the Invention

An embodiment of the present disclosure relates to a memory system, a storage apparatus, and a control method.

### Description of the Related Art

A storage apparatus including a non-volatile memory such as a universal flash storage (UFS), an embedded multimedia card (eMMC), and a solid-state drive (SSD) has been known.

### BRIEF DESCRIPTION OF THE DRAWINGS

FIG. 1 is a functional block diagram of a memory system 101 according to the present embodiment;

FIG. 2 shows a state transition diagram of operation modes of the memory system 101;

FIG. 3 is a sequence diagram showing an internal processing operation of the memory system 101 when the memory system 101 receives an external read instruction from a host device 111 in a normal mode M1;

FIG. 4 is a sequence diagram showing an internal processing operation of the memory system 101 when the memory system 101 receives a plurality of external read instructions from the host device 111 in a high temperature mode M2;

FIG. 5 is a sequence diagram showing an internal processing operation of the memory system 101 when the memory system 101 receives a plurality of external read instructions from the host device 111 in a case in which the operation mode transitions from the high temperature mode M2 to a performance suppression mode M3;

FIG. 6 is a diagram showing one example of a change of electricity consumption with respect to performance of the memory system 101;

FIG. 7 is a diagram showing one example of a change of a temperature Tc with respect to electricity consumption of the memory system 101;

FIG. 8 is a diagram showing one example of a time change of the temperature when performance suppression is performed in a related-art memory system;

FIG. 9 is a diagram showing one example of a time change of the temperature Tc when a threshold value Tth is set to 90° C. and 100° C. in the memory system 101;

FIG. 10 is a diagram showing one example of a temperature change of leak current;

FIG. 11 is a diagram showing one example of each of temperature changes of the memory system 101 when the memory system 101 exhibits a performance of 100% and a performance of 90%;

FIG. 12 is a diagram showing one example of a time change of an operation current Icc in a case in which the memory system 101 performs a consecutive sequential read operation;

FIG. 13 is a diagram showing one example of a time change of the operation current Icc in a case in which a memory system of a comparative example performs a consecutive sequential read operation;

FIG. 14 is a diagram showing one example of a time change of the operation current Icc in a case in which the memory system of the comparative example performs a consecutive random read operation; and

FIG. 15 is a diagram showing one example of a time change of the operation current Icc in a case in which the memory system 101 performs a consecutive random read operation.

### DETAILED DESCRIPTION OF THE INVENTION

An embodiment of the present disclosure is described below with reference to the accompanying drawings. In order to facilitate the understanding of the description, the same components are denoted by the same reference characters to the extent possible in each of the drawings, and overlapping descriptions are omitted.

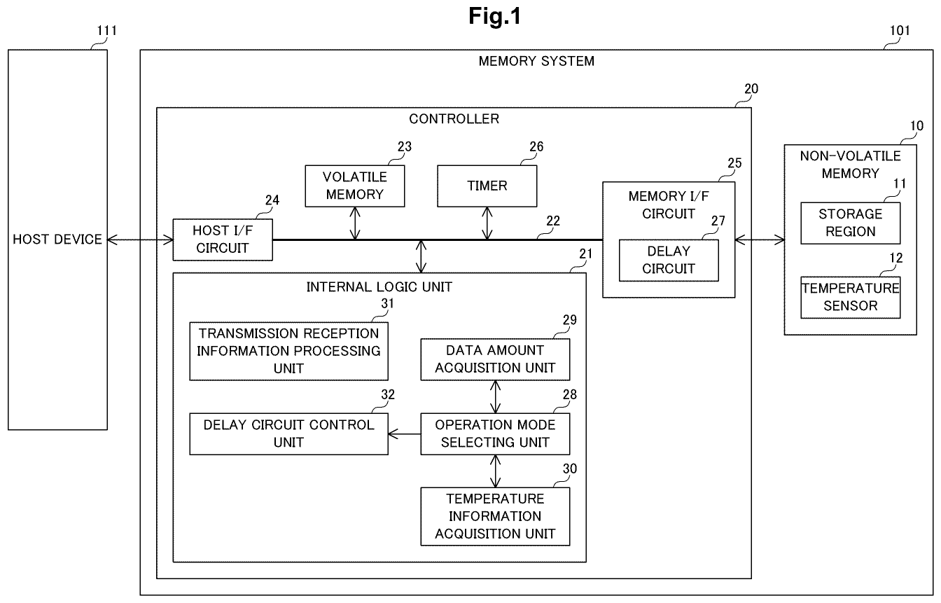

FIG. 1 is a functional block diagram of a memory system 101 according to the present embodiment. The memory system 101 (one example of a “storage apparatus”) includes a non-volatile memory 10 (one example of a “memory”) and a controller 20.

The controller 20 includes an internal logic unit 21 (one example of a “control unit”), a bus 22, a volatile memory 23, a host interface (I/F) circuit 24, a memory interface (I/F) circuit 25, a timer 26, and a delay circuit 27. Specifically, the controller 20 is a controller chip.

The memory system 101 may be a UFS device that complies with a universal flash storage (UFS) standard (for example, JESD220F), for example. The UFS standard is a standard of a NAND-type flash memory for digital cameras, smartphones, and home appliances and is developed by Joint Electron Device Engineering Councils (JEDEC).

The non-volatile memory 10 includes a non-volatile storage region 11 and a temperature sensor 12. Specifically, the non-volatile memory 10 is a memory chip. The storage region 11 in the non-volatile memory 10 is a memory cell array, for example. Data stored in the storage region 11 is maintained even when electricity is not supplied.

In the present embodiment, the non-volatile memory 10 is a semiconductor memory. Specifically, the non-volatile memory 10 is a NAND-type flash memory.

The non-volatile memory 10 may be a magnetoresistive random access memory (MRAM), a phase change random access memory (PRAM), a resistive random access memory (ReRAM), or a ferroelectric random access memory (FeRAM).

The non-volatile memory 10 can read and write data from and to the storage region 11. Specifically, the non-volatile memory 10 includes a controller (one example of a “memory control unit”), for example.

The non-volatile memory 10 is configured to be able to execute a writing operation of data and a read-out operation of data in predetermined writing units in accordance with internal instruction information received from the controller 20.

In addition, the non-volatile memory 10 is configured to be able to erase data in erase units including a plurality of writing units. For example, when the non-volatile memory 10 is a NAND-type flash memory, the non-volatile memory 10 is configured to perform the writing operation and the read-out operation in units of pages and erase data in units of blocks including a plurality of pages.

In detail, the non-volatile memory 10 includes, besides the storage region 11, an interface circuit (input-output circuit) for exchanging information with the controller 20, a sense amplifier for reading out information stored in the memory cell array and transmitting information to be written into the memory cell array, a data register for storing therein data and other information that the interface circuit has received from the controller 20 or storing therein data and other information read from the memory cell array with use of the sense amplifier, a status register for storing therein the status of the non-volatile memory 10, an address register for storing therein physical address information and the like that the interface circuit has received from the controller 20, a row decoder and a column decoder for accessing a predetermined memory cell in accordance with the physical address information stored in the address register, a command register for storing therein instruction information that the interface circuit has received from the controller 20, a sequencer for controlling the sense amplifier, the data register, the status register, the row decoder, the column decoder, and the like and executing a writing operation, a read-out operation, an erase operation, and the like, for example, in accordance with various instruction information stored in the command register.

The temperature sensor 12 acquires temperature information indicating the temperature of the memory system 101. In the present embodiment, the temperature sensor 12 is a sensor circuit formed in the non-volatile memory 10. The sensor circuit is formed in the vicinity of a circuit of the storage region 11. The temperature sensor 12 acquires temperature information indicating the temperature of the non-volatile memory 10.

The temperature sensor 12 is not limited to a configuration of being formed in the non-volatile memory 10 and may be formed in the controller 20 or may be provided in the vicinity of the non-volatile memory 10 or the controller 20, for example. The temperature sensor 12 may be provided in a yet different position and may be configured to acquire the temperature information indicating the temperature of the memory system 101 or the non-volatile memory 10 by performing correction based on a predetermined correction factor and the like. The temperature sensor 12 only needs to be a thermocouple or a semiconductor temperature sensor that measures the temperature with use of an electrical property in which the band gap of a semiconductor changes in accordance with the temperature change, for example.

The host device 111 transmits external instruction information including an instruction that causes the non-volatile memory 10 to read and write data to the memory system 101. Specifically, the instruction that causes the non-volatile memory 10 to read and write data is an external read instruction or an external write instruction.

The external read instruction is an instruction for reading out data to be read out of the data stored in the non-volatile memory 10.

In detail, the external read instruction includes a logical address of data to be read out and the size of the data to be read out.

When the memory system 101 receives an external read instruction, the memory system 101 acquires data to be read out from the non-volatile memory 10 in accordance with the external read instruction. Then, the memory system 101 transmits the data to be read out that has been acquired and response information indicating that the external read instruction is completed to the host device 111.

The external write instruction is an instruction for writing data (may hereinafter be referred to as data to be written) to the non-volatile memory 10.

In detail, the external write instruction includes a logical address to which the data to be written is to be written and the size of the data to be written. The external write instruction may include the data to be written or be accompanied by the data to be written.

When the memory system 101 receives an external write instruction, the memory system 101 causes the non-volatile memory 10 to store therein the data to be written in accordance with the external write instruction. Then, the memory system 101 transmits response information indicating that the external write instruction is completed to the host device 111.

The host device 111 is a UFS host that complies with a UFS standard (for example, JESD220F), for example. Specifically, the host device 111 is a personal computer, a mobile information terminal, or the like.

The controller 20 in the memory system 101 controls the operation of the non-volatile memory 10 including the writing operation of the data and the read-out operation of the data.

In the controller 20, the internal logic unit 21, the volatile memory 23, the host interface circuit 24, the memory interface circuit 25, and the timer 26 are connected to each other via the bus 22.

The host interface circuit 24 is a front-end of the controller 20 and communicably connects the host device 111 and the controller 20 to each other.

The host interface circuit 24 receives the external read instruction, the external write instruction, and the data to be written from the host device 111.

The host interface circuit 24 performs serial communication with the host device 111, for example. The host interface circuit 24 converts serial data received from the host device to parallel data and outputs the parallel data to the bus 22.

The host interface circuit 24 converts the parallel data received from the bus 22 to serial data and transmits the serial data to the host device 111, for example.

For example, when the memory system 101 is a UFS device, the host interface circuit 24 includes a transport layer using a mobile industry processor interface unified protocol (MIPI UniPro) that complies with the MIPI UniPro™ standard and a MIPI M-PHY physical layer that complies with the MIPI M-PHY™ standard.

The host interface circuit 24 has a physical configuration for transmitting and receiving DIN, DIN_C that are a differential signal pair and are information (data) received from the host device 111, DOUT, DOUT_C that are a differential signal pair and are information (data) transmitted to the host device 111, a reference clock signal, power supply voltage, and the like.

The memory interface circuit 25 is a back-end of the controller 20 and communicably connects the non-volatile memory 10 and the controller 20 to each other. The memory interface circuit 25 has a configuration that complies with the ONFI standard or the Toggle DDR standard, for example.

The volatile memory 23 is a volatile storage apparatus. Specifically, the volatile memory 23 is a static random access memory (SRAM). The volatile memory 23 may be a dynamic random access memory (DRAM) provided outside the controller 20. The volatile memory 23 is a buffer that temporarily stores therein various instructions, data, and the like.

The internal logic unit 21 is a central processing unit (CPU), for example. The internal logic unit 21 operates as a processing unit that processes an instruction from the host device 111 by executing firmware (one example of a computer program).

The firmware is stored in the non-volatile memory 10, for example. The firmware is transferred to the volatile memory 23 from the non-volatile memory 10. The internal logic unit 21 executes the firmware stored in the volatile memory 23.

The internal logic unit 21 causes the volatile memory 23 to store therein data necessary for the execution of the firmware at the time of execution of the firmware. The internal logic unit 21 reads out instructions and data necessary for the execution of the firmware from the volatile memory 23 and executes arithmetic processing in accordance with the content of the processing instruction. At this time, the internal logic unit 21 may newly generate data necessary for the execution of the firmware and save the data in the volatile memory 23.

The internal logic unit 21 includes an operation mode selecting unit 28, a data amount acquisition unit 29, a temperature information acquisition unit 30, a transmission reception information processing unit 31 (one example of an “instruction information processing unit”), and a delay circuit control unit 32 as functional blocks.

The transmission reception information processing unit 31 in the internal logic unit 21 generates internal instruction information corresponding to the external instruction information. Specifically, the internal instruction information includes internal read instruction and internal write instruction corresponding to the external read instruction and the external write instruction, respectively. The internal read instruction and the internal write instruction are internal commands executable by the non-volatile memory 10.

The transmission reception information processing unit 31 temporarily stores the external read instruction, the external write instruction, and the data to be written output to the bus 22 by the host interface circuit 24 into the volatile memory 23, for example.

The transmission reception information processing unit 31 manages a logical address and a physical address of the non-volatile memory 10. In detail, the transmission reception information processing unit 31 manages a logical-physical conversion table indicating a correspondence relationship between a logical address of the storage region 11 and a physical address of the storage region 11 in the non-volatile memory 10.

The logical-physical conversion table is stored in the storage region 11, for example, and is transferred to the volatile memory 23 at the time of execution of the firmware.

When the transmission reception information processing unit 31 stores an external read instruction output to the bus 22 by the host interface circuit 24 into the volatile memory 23, the transmission reception information processing unit 31 generates an internal read instruction based on the external read instruction and the logical-physical conversion table.

In detail, the transmission reception information processing unit 31 converts the logical address included in the external read instruction to a physical address based on the logical-physical conversion table, for example. The transmission reception information processing unit 31 generates an internal read instruction including the physical address and the size of the data to be read out and stores the internal read instruction into the volatile memory 23 as the data to be transmitted to the non-volatile memory 10 (may hereinafter be referred to as data waiting to be transmitted).

When the transmission reception information processing unit 31 stores the external write instruction and the data to be written output to the bus 22 by the host interface circuit 24 into the volatile memory 23, the transmission reception information processing unit 31 performs processing below.

Specifically, the transmission reception information processing unit 31 generates an internal write instruction based on the external write instruction and the logical-physical conversion table.

In detail, the transmission reception information processing unit 31 converts the logical address included in the external write instruction to a physical address based on the logical-physical conversion table, for example. The transmission reception information processing unit 31 generates an internal write instruction including the physical address and the size of the data to be written.

The transmission reception information processing unit 31 converts the data to be written to a format suitable for storage in the non-volatile memory 10.

The transmission reception information processing unit 31 stores an internal write instruction and data to be written that is the target of the internal write instruction into the volatile memory 23 as data waiting to be transmitted.

The memory interface circuit 25 transmits internal instruction information to the non-volatile memory 10. Specifically, the memory interface circuit 25 transmits an internal read instruction, an internal write instruction, and data to be written to the non-volatile memory 10.

In the present embodiment, the memory interface circuit 25 performs parallel communication with the non-volatile memory 10, for example. The memory interface circuit 25 receives data waiting to be transmitted stored in the volatile memory 23 through the bus 22 and transmits the data waiting to be transmitted that has been received to the non-volatile memory 10.

Here, the data waiting to be transmitted is stored into the volatile memory 23 by a data structure of a queue. In other words, the internal read instruction, the internal write instruction, and the data to be written that are stored in the volatile memory 23 are transmitted to the non-volatile memory 10 through the memory interface circuit 25 in the order of being stored into the volatile memory 23.

The delay circuit 27 performs thermal throttling processing that delays the execution of the internal read instruction and the internal write instruction by the non-volatile memory 10 (may hereinafter be referred to as instruction execution by the non-volatile memory 10). In the present embodiment, the delay circuit 27 is provided in the memory interface circuit 25.

In the present embodiment, the delay circuit 27 performs the thermal throttling processing by preventing the internal instruction information from being transmitted to the non-volatile memory 10 from the memory interface circuit 25 during predetermined delay time.

In other words, the delay circuit 27 delays a timing at which the memory interface circuit 25 transmits the internal read instruction, the internal write instruction, and the data to be written to the non-volatile memory 10.

In detail, the delay circuit 27 includes a timer, for example. The amount of time measured by the timer, in other words, the delay time is set by the internal logic unit 21. When the operation of the timer of the delay circuit 27 starts, the memory interface circuit 25 is placed in a state that does not receive the data waiting to be transmitted stored in the volatile memory 23 until the timer expires.

In other words, while the delay circuit 27 is operating, the data waiting to be transmitted stored in the volatile memory 23 is not transmitted to the non-volatile memory 10 from the memory interface circuit 25 and the data waiting to be transmitted generated by the transmission reception information processing unit 31 is piled up in a transmission queue of the volatile memory 23. Then, the delay time is added to a transmission interval between two pieces of data waiting to be transmitted that are to be successively transmitted.

The delay circuit 27 may be a configuration in which a circuit that stores therein data waiting to be transmitted until a predetermined amount of time (a predetermined number of counts) elapses and a flip-flop circuit having a predetermined delay amount are connected to each other in series by a plurality of numbers, for example.

The timer 26 measures unit time in accordance with the control from the internal logic unit 21. The unit time may be a freely-selected length.

In detail, when the unit time is set by the internal logic unit 21, the timer 26 measures the amount of time from the set timing. When the amount of time that is being measured and the unit time coincide, the timer 26 notifies the internal logic unit 21 of the expiration of the timer.

When the non-volatile memory 10 receives an internal read instruction from the controller 20, the non-volatile memory 10 performs the read-out operation of data. In detail, the non-volatile memory 10 reads out data to be read out from a part of the storage region 11 indicated by a physical address included in the internal read instruction and transmits the data to be read out to the memory interface circuit 25 in accordance with the internal read instruction.

When the non-volatile memory 10 receives the internal write instruction and the data to be written, the non-volatile memory 10 performs the writing operation of the data. In detail, the non-volatile memory 10 writes the data to be written to a part of the storage region 11 indicated by a physical address included in the internal write instruction in accordance with the internal write instruction.

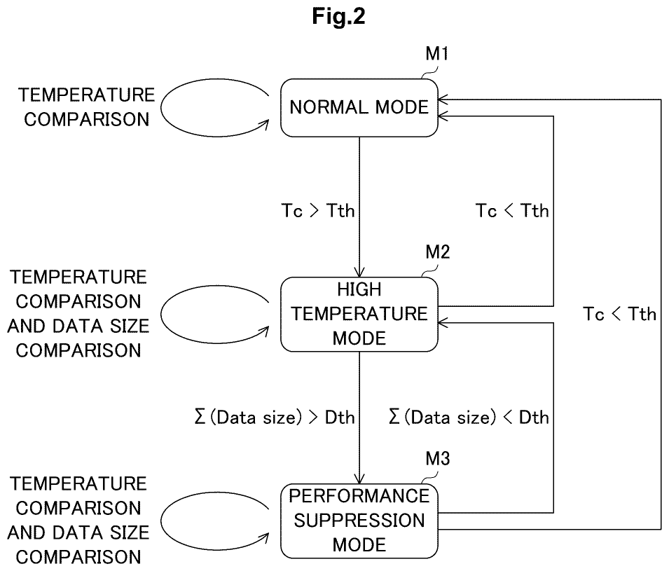

FIG. 2 shows a state transition diagram of operation modes of the memory system 101. With reference to FIG. 1 and FIG. 2, the operation mode selecting unit 28 in the internal logic unit 21 sets the operation mode of the memory system 101 to any of a normal mode M1, a high temperature mode M2, and a performance suppression mode M3.

The temperature information acquisition unit 30 repeatedly acquires temperature information from the temperature sensor 12 and outputs the temperature information to the operation mode selecting unit 28. In the present embodiment, the temperature information acquisition unit 30 repeatedly acquires the temperature information at a cycle in accordance with the operation mode set by the operation mode selecting unit 28, for example. The cycle of acquiring the temperature information may be the same for each of the operation modes of the memory system 101 or some or all may be different.

Specifically, the temperature information acquisition unit 30 monitors the operation of the operation mode selecting unit 28 and sets the cycle to N milliseconds, M milliseconds, and M milliseconds when the normal mode M1, the high temperature mode M2, or the performance suppression mode M3 is set by the operation mode selecting unit 28, respectively. Here, N is greater than M.

The data amount acquisition unit 29 repeatedly performs unit time I/O data amount acquisition processing of acquiring a data amount read and written by the non-volatile memory 10 during the unit time (may hereinafter be referred to as a unit time I/O data amount) and outputs the acquired unit time I/O data amount to the operation mode selecting unit 28.

In the present embodiment, the data amount acquisition unit 29 monitors the operation of the operation mode selecting unit 28 and acquires a unit time I/O data amount when the high temperature mode M2 or the performance suppression mode M3 is set by the operation mode selecting unit 28. The unit time may be a freely-selected amount of time. The data amount acquisition unit 29 may set the unit time to be a statically fixed amount of time or a dynamically changing amount of time.

In detail, the data amount acquisition unit 29 sets the unit time for the timer 26 and performs integration processing below until the data amount acquisition unit 29 receives a notification of expiration from the timer 26.

Specifically, for example, each time an internal read instruction is generated based on the external read instruction, the data amount acquisition unit 29 acquires the size of the data to be read out included in the external read instruction or the internal read instruction. The data amount acquisition unit 29 acquires the data amount read out by the non-volatile memory 10 during the unit time (may hereinafter be referred to as a unit time read-out data amount) by integrating the acquired size.

For example, each time an internal write instruction is generated based on the external write instruction, the data amount acquisition unit 29 acquires the size of the data to be written included in the external write instruction or the internal write instruction. The data amount acquisition unit 29 acquires the data amount written by the non-volatile memory 10 during the unit time (may hereinafter be referred to as a unit time writing data amount) by integrating the acquired size.

The data amount acquisition unit 29 acquires the unit time I/O data amount by summing the unit time read-out data amount and the unit time writing data amount that have been acquired and outputs the unit time I/O data amount to the operation mode selecting unit 28. The data amount acquisition unit 29 repeatedly performs the unit time I/O data amount acquisition processing when the operation mode is the high temperature mode M2 or the performance suppression mode M3.

### [Normal Mode M1]

The normal mode M1 is an operation mode in which the memory system 101 operates in accordance with an external read instruction and an external write instruction from the host device 111.

The operation mode selecting unit 28 sets the normal mode M1 as an initial value of the operation mode, for example. In the normal mode M1, the operation mode selecting unit 28 performs temperature comparison processing of comparing a temperature Tc and a threshold value Tth (one example of a “second threshold value”) indicated by temperature information with each other each time the temperature information is periodically received from the temperature information acquisition unit 30.

The operation mode selecting unit 28 causes the operation mode to transition from the normal mode M1 to the high temperature mode M2 when the temperature Tc becomes higher than the threshold value Tth in a case in which the operation mode is the normal mode M1. The threshold value Tth may be a predetermined value selected from a temperature range of 80 degrees to 95 degrees, for example.

Meanwhile, the operation mode selecting unit 28 maintains the operation mode at the normal mode M1 when the temperature Tc is equal to or less than the threshold value Tth in a case in which the operation mode is the normal mode M1.

### [High Temperature Mode M2]

When the high temperature mode M2 is compared to the normal mode M1, the high temperature mode M2 is an operation mode that further monitors the unit time I/O data amount.

In the high temperature mode M2, the operation mode selecting unit 28 performs the temperature comparison processing described above and performs data size comparison processing of comparing a unit time I/O data amount and a threshold value Dth (one example of a “first threshold value”) each time the unit time I/O data amount is repeatedly received from the data amount acquisition unit 29.

The operation mode selecting unit 28 maintains the operation mode at the high temperature mode M2 when the unit time I/O data amount, in other words, Σ(Data size) is equal to or less than the threshold value Dth in a case in which the operation mode is the high temperature mode M2 and the temperature Tc is equal to or more than the threshold value Tth. The threshold value Dth may be a predetermined value selected from 2000 MiB to 3500 MiB, for example.

The operation mode selecting unit 28 causes the operation mode to transition from the high temperature mode M2 to the performance suppression mode M3 when Σ(Data size) becomes greater than the threshold value Dth in a case in which the operation mode is the high temperature mode M2 and the temperature Tc is equal to or more than the threshold value Tth.

Meanwhile, the operation mode selecting unit 28 causes the operation mode to transition from the high temperature mode M2 to the normal mode M1 when the temperature Tc becomes lower than the threshold value Tth in a case in which the operation mode is the high temperature mode M2.

### [Performance Suppression Mode M3]

When the performance suppression mode M3 is compared to the high temperature mode M2, the performance suppression mode M3 is an operation mode that further performs thermal throttling processing by the delay circuit 27.

In the performance suppression mode M3, the operation mode selecting unit 28 performs the temperature comparison processing and the data size comparison processing described above.

The operation mode selecting unit 28 maintains the operation mode at the performance suppression mode M3 when Σ(Data size) is equal to or more than the threshold value Dth in a case in which the operation mode is the performance suppression mode M3 and the temperature Tc is equal to or more than the threshold value Tth.

Meanwhile, the operation mode selecting unit 28 causes the operation mode to transition from the performance suppression mode M3 to the high temperature mode M2 when Σ(Data size) becomes lower than the threshold value Dth in a case in which the operation mode is the performance suppression mode M3 and the temperature Tc is equal to or more than the threshold value Tth.

The operation mode selecting unit 28 causes the operation mode to transition from the performance suppression mode M3 to the normal mode M1 when the temperature Tc becomes lower than the threshold value Tth in a case in which the operation mode is the performance suppression mode M3.

The delay circuit control unit 32 controls the delay circuit 27 based on the magnitude relationship between the unit time I/O data amount and the threshold value Dth.

Specifically, when the temperature is equal to or more than the threshold value Tth and the unit time I/O data amount is equal to or more than the threshold value Dth, the delay circuit control unit 32 causes the delay circuit 27 to delay the instruction execution by the non-volatile memory 10, for example.

More specifically, in a case in which the delay circuit control unit 32 performs control that does not cause the delay circuit 27 to delay the instruction execution by the non-volatile memory 10, for example, the delay circuit control unit 32 causes the delay circuit 27 to start the thermal throttling processing when the temperature Tc becomes equal to or more than the threshold value Tth and the unit time I/O data amount becomes greater than the threshold value Dth.

In the present embodiment, the delay circuit control unit 32 monitors the operation of the operation mode selecting unit 28, and causes the delay circuit 27 to operate by setting delay time for the timer included in the delay circuit 27 when the performance suppression mode M3 is set by the operation mode selecting unit 28.

Meanwhile, the delay circuit control unit 32 stops the delay circuit 27 when the normal mode M1 or the high temperature mode M2 is set by the operation mode selecting unit 28.

In the performance suppression mode M3, when the delay circuit 27 operates, the data waiting to be transmitted stored in the volatile memory 23 is not transmitted to the non-volatile memory 10 until the delay time elapses after the operation is performed.

In other words, the amount of time from when the host interface circuit 24 receives the external instruction information to when the memory interface circuit 25 transmits the corresponding internal instruction information to the non-volatile memory 10 is longer when the delay circuit control unit 32 causes the delay circuit 27 to delay the instruction execution by the non-volatile memory 10 as compared to when the delay circuit control unit 32 does not cause the delay circuit 27 to delay the instruction execution by the non-volatile memory 10.

### [Operation]

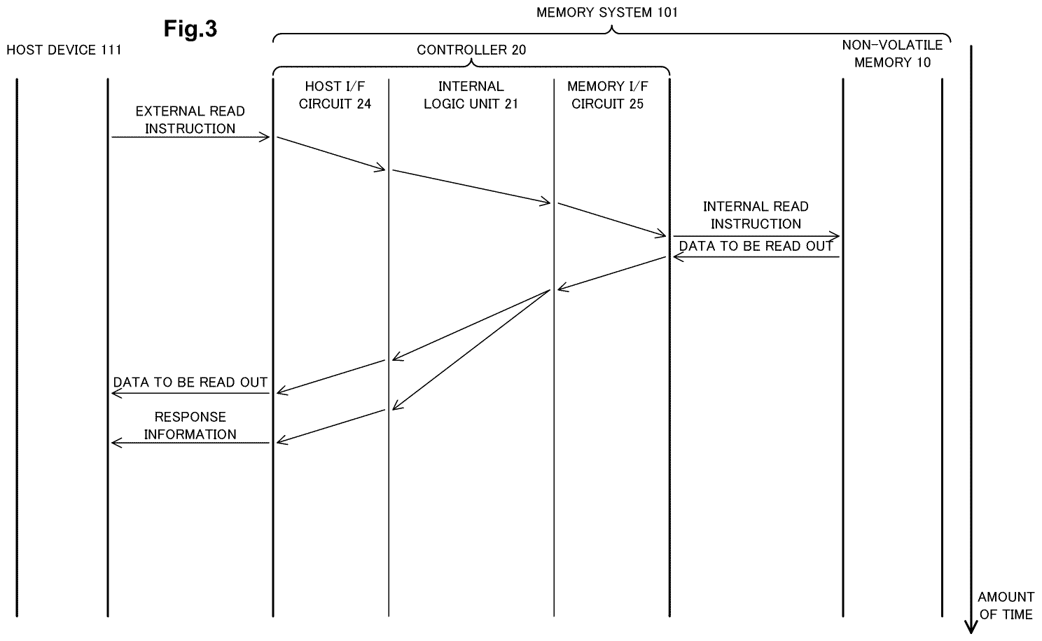

FIG. 3 is a sequence diagram showing an internal processing operation of the memory system 101 when the memory system 101 receives an external read instruction from the host device 111 in the normal mode M1.

With reference to FIG. 1 and FIG. 3, the host device 111 transmits an external read instruction to the memory system 101.

More specifically, the external read instruction is an external sequential read instruction or an external random read instruction. More specifically, the internal read instruction is an internal sequential read instruction or an internal random read instruction. The internal sequential read instruction and the internal random read instruction are based on the external sequential read instruction and the external random read instruction, respectively.

The external sequential read instruction and the internal sequential read instruction are instructions for causing the non-volatile memory 10 to read out each of data stored in each region having a plurality of consecutive addresses in the storage region 11 from each region in the order of the addresses. Here, the address is a logical address and a physical address in the external sequential read instruction and the internal sequential read instruction, respectively.

The external random read instruction and the internal random read instruction are instructions for causing the non-volatile memory 10 to read out each of data stored in each region having a plurality of addresses that are not consecutive in the storage region 11 from each region. Here, the address is a logical address and a physical address in the external random read instruction and the internal random read instruction, respectively.

Although not shown, more specifically, the external write instruction is an external sequential write instruction or an external random write instruction. More specifically, the internal write instruction is an internal sequential write instruction or an internal random write instruction. The internal sequential write instruction and the internal random write instruction are based on the external sequential write instruction and the external random write instruction, respectively.

The external sequential write instruction and the internal sequential write instruction are instructions for causing the non-volatile memory 10 to write each of data to be written to each region having a plurality of consecutive addresses in the storage region 11 in the order of the addresses. Here, the address is a logical address and a physical address in the external sequential write instruction and the internal sequential write instruction, respectively.

The external random write instruction and the internal random write instruction are instructions for causing the non-volatile memory 10 to write each of data to be written to each region having a plurality of addresses that are not consecutive in the storage region 11. Here, the address is a logical address and a physical address in the external random write instruction and the internal random write instruction, respectively.

The operation mode of the internal logic unit 21 in the controller 20 is set to the normal mode M1. When the internal logic unit 21 receives an external read instruction through the host interface circuit 24, the internal logic unit 21 generates an internal read instruction corresponding to the external read instruction based on the external read instruction.

The internal logic unit 21 transmits the generated internal read instruction to the non-volatile memory 10 through the memory interface circuit 25.

When the non-volatile memory 10 receives the internal read instruction, the non-volatile memory 10 acquires data to be read out in accordance with the internal read instruction and transmits the data to be read out to the controller 20.

When the memory interface circuit 25 receives the data to be read out from the non-volatile memory 10, the memory interface circuit 25 outputs the data to be read out to the internal logic unit 21 through the bus 22. The data to be read out may be temporarily buffered in the volatile memory 23.

When the internal logic unit 21 receives the data to be read out from the memory interface circuit 25, the internal logic unit 21 converts the data unit of the data to be read out to the data unit managed by the host device 111. The internal logic unit 21 generates response information indicating that the external read instruction is completed.

The internal logic unit 21 outputs the data to be read out and the response information to the host interface circuit 24 through the bus 22. The data to be read out and the response information may be temporarily buffered in the volatile memory 23.

When the host interface circuit 24 receives the data to be read out and the response information from the internal logic unit 21, the host interface circuit 24 transmits the data to be read out and the response information to the host device 111.

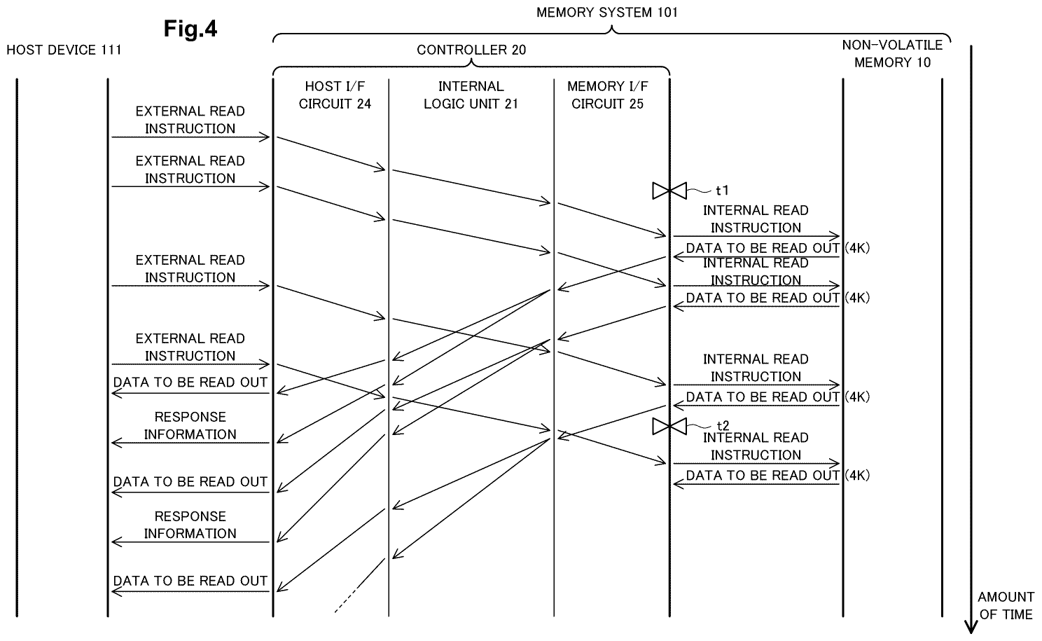

FIG. 4 is a sequence diagram showing an internal processing operation of the memory system 101 when the memory system 101 receives a plurality of external read instructions from the host device 111 in the high temperature mode M2.

With reference to FIG. 1 and FIG. 4, the host device 111 repeatedly transmits an external read instruction to the memory system 101.

The memory system 101 has two or more que depths (QDs), for example. Therefore, the host device 111 can transmit one or more external read instructions to the memory system 101 after transmitting a first external read instruction and before receiving response information thereof.

Specifically, for example, when the number of QDs included in the memory system 101 is eight, the host device 111 can transmit a second external read instruction to an eighth external read instruction to the memory system 101 after transmitting the first external read instruction and before receiving response information thereof.

The operation mode of the internal logic unit 21 in the controller 20 is set to the high temperature mode M2. The internal logic unit 21 repeatedly receives an external read instruction through the host interface circuit 24.

Each time the internal logic unit 21 receives an external read instruction, the internal logic unit 21 generates an internal read instruction corresponding to the external read instruction based on the external read instruction and transmits the generated internal read instruction to the non-volatile memory 10 through the memory interface circuit 25.

The internal logic unit 21 sets the unit time for the timer 26 at time t1, for example, and measures the unit time I/O data amount until an expiration notification is received from the timer 26.

Each time the non-volatile memory 10 receives an internal read instruction, the non-volatile memory 10 acquires data to be read out in accordance with the internal read instruction and transmits the data to be read out to the controller 20. In an example shown in FIG. 4, the size of the data to be read out is 4 kilobytes (KB).

Each time the memory interface circuit 25 receives the data to be read out from the non-volatile memory 10, the memory interface circuit 25 outputs the data to be read out to the internal logic unit 21 through the bus 22.

When the internal logic unit 21 receives the data to be read out from the memory interface circuit 25, the internal logic unit 21 converts the data unit of the data to be read out to the data unit managed by the host device 111, and generates response information.

The internal logic unit 21 outputs the data to be read out and the response information to the host interface circuit 24 through the bus 22.

At time t2, for example, when the internal logic unit 21 receives an expiration notification from the timer 26, the internal logic unit 21 compares the measured unit time I/O data amount and the threshold value Dth with each other.

In the example shown in FIG. 4, the unit time I/O data amount (for example, 12 KB) is equal to or less than the threshold value Dth, and hence the operation mode of the memory system 101 is maintained at the high temperature mode M2. Therefore, the memory system 101 maintains the delay circuit 27 to be stopped, and hence the timing at which each internal read instruction is transmitted is not delayed.

Each time the host interface circuit 24 receives the data to be read out and the response information from the internal logic unit 21, the host interface circuit 24 transmits the data to be read out and the response information to the host device 111.

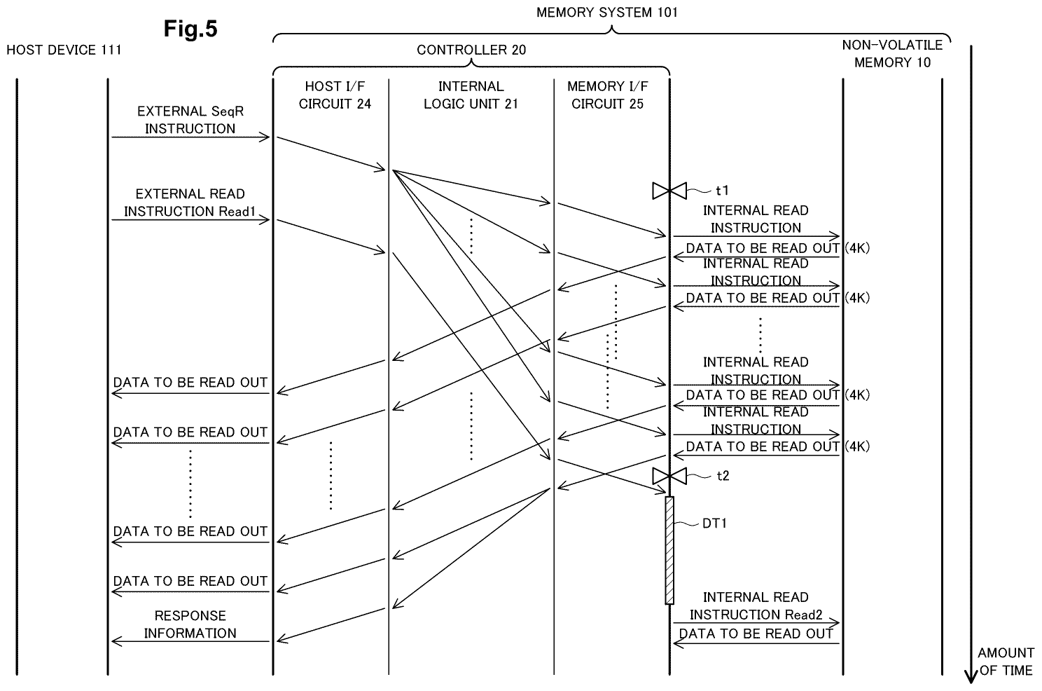

FIG. 5 is a sequence diagram showing an internal processing operation of the memory system 101 when the memory system 101 receives a plurality of external read instructions from the host device 111 in a case in which the operation mode transitions from the high temperature mode M2 to a performance suppression mode M3.

With reference to FIG. 1 and FIG. 5, the host device 111 transmits an external sequential read (SeqR) instruction to the memory system 101.

The operation mode of the internal logic unit 21 in the controller 20 is set to the high temperature mode M2. The internal logic unit 21 receives an external SeqR instruction through the host interface circuit 24.

When the internal logic unit 21 receives the external SeqR instruction, the internal logic unit 21 generates a plurality of internal read instructions for causing the non-volatile memory 10 to read out each of data stored in each region having a plurality of consecutive physical addresses from each region in the order of the addresses based on the external SeqR instruction. In the example shown in FIG. 5, the internal logic unit 21 generates four internal read instructions.

The internal logic unit 21 repeatedly transmits the four generated internal read instructions to the non-volatile memory 10 through the memory interface circuit 25.

The internal logic unit 21 sets the unit time for the timer 26 at time t1, for example, and measures the unit time I/O data amount until an expiration notification is received from the timer 26.

Each time the non-volatile memory 10 receives an internal read instruction, the non-volatile memory 10 acquires data to be read out in accordance with the internal read instruction and transmits the data to be read out to the controller 20. In an example shown in FIG. 5, the size of the data to be read out is 4 kilobytes (KB).

Each time the memory interface circuit 25 receives the data to be read out from the non-volatile memory 10, the memory interface circuit 25 outputs the data to be read out to the internal logic unit 21 through the bus 22.

Each time the internal logic unit 21 receives the data to be read out from the memory interface circuit 25, the internal logic unit 21 converts the data unit of the data to be read out to the data unit managed by the host device 111.

When the internal logic unit 21 confirms that the four pieces of data to be read out acquired by the four internal read instructions have been received, the internal logic unit 21 generates response information.

The internal logic unit 21 repeatedly outputs the four pieces of data to be read out to the host interface circuit 24 through the bus 22. Then, the internal logic unit 21 outputs response information to the host interface circuit 24 through the bus 22.

At time t2, for example, when the internal logic unit 21 receives an expiration notification from the timer 26, the internal logic unit 21 compares the measured unit time I/O data amount and the threshold value Dth with each other.

In the example shown in FIG. 5, the unit time I/O data amount (for example, from 2500 MB/S to 4000 MB/S) is greater than the threshold value Dth, and hence the internal logic unit 21 causes the operation mode to transition from the high temperature mode M2 to the performance suppression mode M3. Then, the internal logic unit 21 operates the delay circuit 27.

As a result, the data waiting to be transmitted is not transmitted from the memory interface circuit 25 by the delay circuit 27 until delay time DT1 elapses after the delay circuit 27 starts the operation.

Specifically, an internal read instruction Read2 corresponding to an external read instruction Read1 transmitted from the host device 111 following the external SeqR instruction is data waiting to be transmitted that has not been transmitted to the non-volatile memory 10 at time t2 and therebefore, and hence is transmitted to the non-volatile memory 10 from the memory interface circuit 25 after the delay time DT1 elapses.

Each time the host interface circuit 24 receives data to be read out from the internal logic unit 21, the host interface circuit 24 transmits the data to be read out to the host device 111. When the host interface circuit 24 receives response information from the internal logic unit 21, the host interface circuit 24 transmits the response information to the host device 111.

### Problem to be Solved

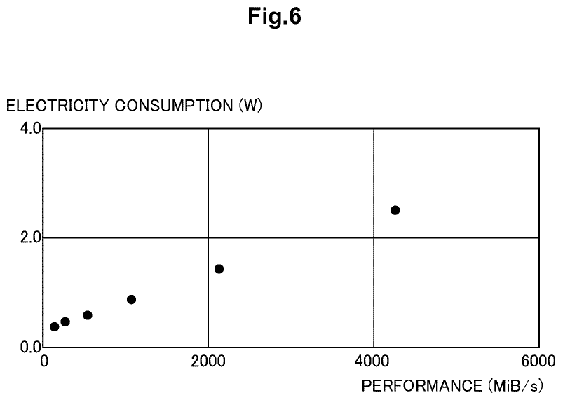

FIG. 6 is a diagram showing one example of a change of electricity consumption with respect to performance of the memory system 101. The vertical axis indicates electricity consumption of which unit is “W”. The horizontal axis indicates the performance of which unit is “MiB/s”. The performance is the unit time I/O data amount, for example.

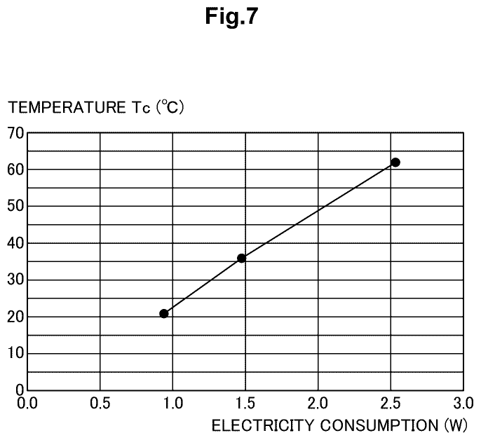

FIG. 7 is a diagram showing one example of a change of the temperature Tc with respect to electricity consumption of the memory system 101. The vertical axis indicates the temperature Tc of which unit is “° C.”. The horizontal axis indicates electricity consumption of which unit is “W”.

As shown in FIG. 6 and FIG. 7, the electricity consumption is substantially proportional to the unit time I/O data amount. The temperature Tc is substantially proportional to the electricity consumption. Therefore, the temperature Tc becomes higher in accordance with the unit time I/O data amount.

When the external random read instruction and the external random write instruction are executed, it takes time to perform conversion from the logical address to the physical address based on the logical-physical conversion table. Therefore, the unit time I/O data amount when the external random read instruction and the external random write instruction are executed is smaller than the unit time I/O data amount when the external sequential read instruction and the external sequential write instruction are executed.

In a memory system of a comparative example, when the temperature Tc rises, performance suppression has been performed regardless of the unit time I/O data amount. The performance suppression is the division of the internal frequency or the provision of a delay amount for each instruction, for example.

Therefore, a delay amount has been provided even for the external random read instruction and the external random write instruction of which unit time I/O data amount is smaller and contribution to heat generation is small, and the processing time for those instructions has also been long.

In the memory system of the comparative example, significant performance suppression is performed after the temperature Tc reaches a high temperature in order to reduce the influence of the performance suppression as much as possible. Therefore, there have been cases in which the pace of the operation of the host device 111 becomes slow after the performance suppression is performed.

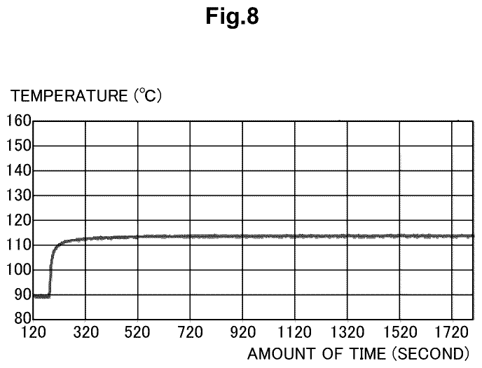

FIG. 8 is a diagram showing one example of a time change of the temperature when performance suppression is performed in a related-art memory system. The vertical axis indicates the temperature Tc of which unit is “° C.”. The horizontal axis indicates the amount of time of which unit is a “second”.

Table 1 shows a result of a simulation of the performance of the memory system of the comparative example at normal times and when the performance suppression is performed.

TABLE 1

| External instruction | | | Performance suppression | |
|---|---|---|---|---|
| information | At normal times | | is performed | |
| External sequential | 4260 | MiB/s | 292 | MiB/s |
| read instruction | | | | |
| External sequential | 3800 | MiB/s | 274 | MiB/s |
| write instruction | | | | |
| External random | 400 | KIOPs | 73 | KIOPs |
| read instruction | | | | |
| External random | 400 | KIOPs | 69 | KIOPs |
| write instruction | | | | |

As shown in FIG. 8 and Table 1, the related-art memory system has a configuration in which performance suppression that drops the performance by 90% is performed when the temperature Tc exceeds 110° C.

Even though significant performance suppression is performed after the temperature Tc exceeds 110° C. and even though the unit time I/O data amount significantly decreases, the temperature Tc does not decrease and is maintained at about 114° C.

### [Threshold Value Tth]

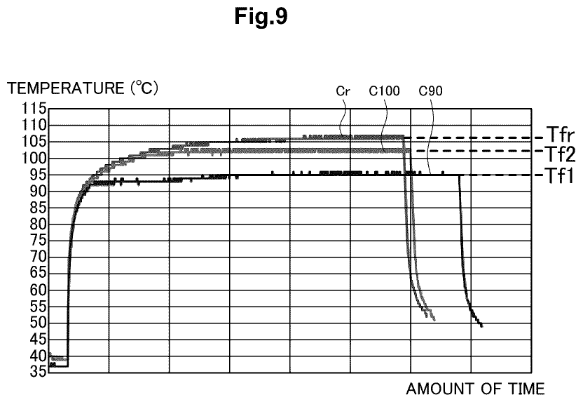

FIG. 9 is a diagram showing one example of a time change of the temperature Tc when the threshold value Tth is set to 90° C. and 100° C. in the memory system 101. The vertical axis indicates temperature of which unit is “° C.”. The horizontal axis indicates the amount of time.

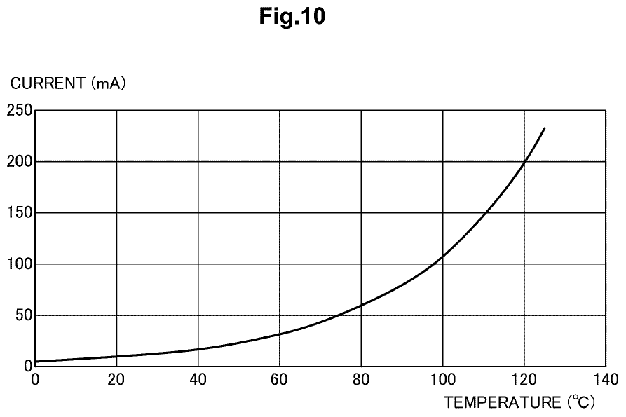

FIG. 10 is a diagram showing one example of a temperature change of leak current. The vertical axis indicates leak current of which unit is “mA”. The horizontal axis indicates temperature of which unit is “° C.”. Here, the leak current is current that constantly flows. The leak current is obtained by subtracting active current generated by operations of reading and writing data in the memory system 101 from current that flows through the circuits included in the memory system 101.

As shown in FIG. 9 and FIG. 10, a curve Cr indicates a time change of the temperature Tc when the memory system 101 is continuously operated at the performance of 100%.

Curves C90 and C100 indicate a time change of the temperature Tc when the threshold value Tth is set to 90° C. and 100° C., respectively, and the memory system 101 is continuously operated at the performance of 100%.

In this example, when the temperature Tc exceeds the threshold value Tth, the performance of the memory system 101 becomes 82% by the thermal throttling processing by the delay circuit 27.

Here, the performance of 100% is the unit time I/O data amount of the memory system 101 when the delay circuit 27 is not caused to perform the thermal throttling processing and the external sequential read instruction or the external sequential write instruction is repeatedly transmitted to the memory system 101 from the host device 111 such that data waiting to be transmitted piles up in the transmission queue of the volatile memory 23, for example.

The performance of 82% is a performance when the delay circuit 27 is caused to execute the thermal throttling processing such that the unit time I/O data amount becomes 82% of the performance of 100%, for example.

A reaching temperature Tf1 in a case in which the threshold value Tth is 90° C. can be reduced by about 12° C. as compared to a reaching temperature Tfr when the delay circuit 27 is not caused to perform the thermal throttling processing.

Meanwhile, a reaching temperature Tf2 in a case in which the threshold value Tth is 100° C. only decreases by about 4° C. as compared to the reaching temperature Tfr.

Even when the same thermal throttling processing is performed, a difference in the reaching temperature occurs due to reasons below.

Specifically, the leak current in the memory system 101 increases in an exponential manner with respect to the temperature (see FIG. 10).

Therefore, the heat generation amount by the leak current at the reaching temperature Tf2 is significantly greater than the heat generation amount by the leak current at the reaching temperature Tf1. Therefore, even when the same thermal throttling processing is performed, the temperature decrease from the reaching temperature Tfr in a case in which the threshold value Tth is 100° C. is smaller than the temperature decrease from the reaching temperature Tfr in a case in which the threshold value Tth is 90° C.

The inventors of the present invention have focused on how the effect of the temperature decrease becomes low due to the leak current in a state in which the temperature has become close to the reaching temperature Tfr even when strong thermal throttling processing is performed, and have conceived of a configuration of performing the thermal throttling processing from an early timing.

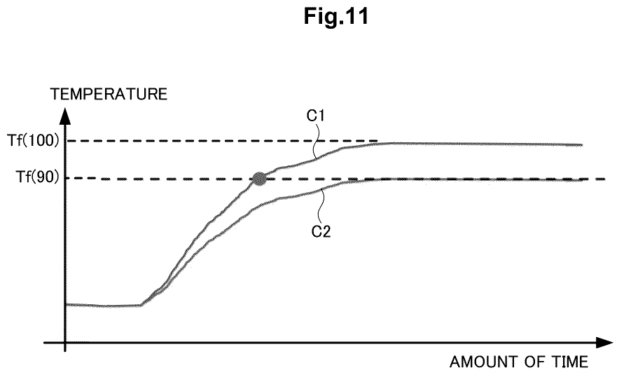

FIG. 11 is a diagram showing one example of each of temperature changes of the memory system 101 when the memory system 101 exhibits a performance of 100% and a performance of 90%. The vertical axis and the horizontal axis indicate the temperature and the amount of time, respectively.

As shown in FIG. 1, FIG. 10, and FIG. 11, the threshold value Tth is equal to or less than a temperature when the memory system 101 is continuously operated in a state in which the delay circuit 27 is caused to delay the instruction execution by the non-volatile memory 10 in a case in which the non-volatile memory 10 reads and writes data from and to each region having a plurality of consecutive physical addresses in the storage region 11.

In detail, curves C1 and C2 indicate a time change of the temperature Tc when the memory system 101 at room temperature (about 25° C.) is continuously operated at the performance of 100% and 90%, respectively.

The performance of 90% is a performance when the delay circuit 27 is caused to execute the thermal throttling processing such that the unit time I/O data amount becomes 90% of the performance of 100%, for example.

When the memory system 101 is continuously operated at the performance of 100%, the temperature Tc reaches a reaching temperature Tf(100). When the memory system 101 is continuously operated at the performance of 90%, the temperature Tc reaches a reaching temperature Tf(90). Here, the reaching temperature Tf(90) is lower than the reaching temperature Tf(100).

The inventors of the present invention have focused on how a negative influence of heat generation due to the leak current can be reduced by performing the thermal throttling processing before the timing at which the temperature Tc becomes equal to or more than the reaching temperature Tf(90) when the reaching temperature Tf(90) is set as a reference temperature, for example.

The threshold value Tth is equal to or less than the reaching temperature Tf(90), for example. In the present embodiment, the threshold value Dth is the reaching temperature Tf(90).

In a state in which the temperature Tc is the reaching temperature Tf(100), even when the delay circuit 27 is caused to perform the thermal throttling processing so as to obtain the performance of 90%, it is difficult to decrease the temperature Tc to the reaching temperature Tf(90).

This is because the leak current in the memory system 101 increases in an exponential manner with respect to the temperature, and hence the temperature Tc does not easily decrease due to heat generation by the leak current in a state in which the temperature Tc is the reaching temperature Tf(100).

Meanwhile, a method of causing the memory system 101 to operate at the performance of 90% from the start of operation of the memory system 101 can also be conceived. However, the unit time I/O data amount becomes low, and hence the amount of time required for the reading and writing processing becomes longer. Therefore, the method is not preferable.

By the configuration in which the threshold value Tth is set to the reaching temperature Tf(90), an upper limit of the temperature Tc can be set to be close to the reaching temperature Tf(90). In a state in which the temperature Tc is equal to or less than the threshold value Tth, in other words, the reaching temperature Tf(90), the memory system 101 can be caused to operate at the performance of 100%, and hence a case in which the amount of time required for the reading and writing processing becomes long can be suppressed.

### [Threshold Value Dth]

The threshold value Dth is smaller than the unit time I/O data amount in a case in which the non-volatile memory 10 reads and writes data from and to each region having a plurality of consecutive physical addresses in the storage region 11 and is greater than the unit time I/O data amount in a case in which the non-volatile memory 10 reads and writes data from and to each region having a plurality of physical addresses that are not consecutive in the storage region 11.

Specifically, the threshold value Dth is smaller than the unit time I/O data amount in a case in which an external sequential read instruction from the host device 111 is repeatedly received by the memory system 101 such that data waiting to be transmitted piles up in the transmission queue of the volatile memory 23 (may hereinafter be referred to as a consecutive sequential read operation), for example.

The threshold value Dth may be smaller than the unit time I/O data amount in a case in which an external sequential write instruction from the host device 111 is repeatedly received by the memory system 101 such that data waiting to be transmitted piles up in the transmission queue of the volatile memory 23 (may hereinafter be referred to as a consecutive sequential write operation), for example.

The threshold value Dth is greater than the unit time I/O data amount in a case in which an external random read instruction from the host device 111 is repeatedly received by the memory system 101 such that data waiting to be transmitted piles up in the transmission queue of the volatile memory 23 (may hereinafter be referred to as a consecutive random read operation), for example.

The threshold value Dth may be greater than the unit time I/O data amount in a case in which an external random write instruction from the host device 111 is repeatedly received by the memory system 101 such that data waiting to be transmitted piles up in the transmission queue of the volatile memory 23 (may hereinafter be referred to as a consecutive random write operation), for example.

The consecutive sequential read operation and the consecutive sequential write operation may hereinafter be collectively referred to as a consecutive sequential R/W operation. The consecutive random read operation and the consecutive random write operation may hereinafter be collectively referred to as a consecutive random R/W operation.

A result of a simulation of the performance of the memory system 101 when the operation mode is the normal mode M1 and Tc>Tth is satisfied is shown in Table 2.

TABLE 2

| External instruction | | | When Tc > Tth | |
|---|---|---|---|---|
| information | Normal mode M1 | | is satisfied | |
| External sequential | 4260 | MiB/s | 3791.4 | MiB/s |
| read instruction | | | | |
| External sequential | 3800 | MiB/s | 3382 | MiB/s |
| write instruction | | | | |
| External random | 400 | KIOPs | 398 | KIOPs |
| read instruction | | | | |
| External random | 400 | KIOPs | 398 | KIOPs |
| write instruction | | | | |

As shown in Table 2, the simulation is performed by conditions below. Specifically, regarding the performance corresponding to the external sequential read instruction and the external sequential write instruction (may hereinafter be referred to as a sequential performance), in other words, the unit time I/O data amount, the data size read and written by those instructions are 4 GiB, and the number of QDs and the chunk size are eight and 512 KB, respectively.

Regarding the performance corresponding to the external random read instruction and the external random write instruction (may hereinafter be referred to as a random performance), the data size read and written by those instructions is 4 GiB, and the number of QDs, the chunk size, and the number of consecutive commands are 32, 3 KB, and 24576, respectively.

Here, 400 KIOPs that is the random performance in the normal mode M1 is equivalent to about 1600 MiB/s. For example, when the threshold value Dth is set to 3000 MiB/s, the operation mode can be caused to stay in the normal mode M1 or the high temperature mode M2 even when an external random read instruction or an external random write instruction is repeatedly received.

Meanwhile, the operation mode can be caused to transition to the performance suppression mode M3 when an external sequential read instruction or an external sequential write instruction is repeatedly received.

The electricity consumption is substantially proportional to the performance (see FIG. 6), and hence the electricity consumption when the external random read instruction or the external random write instruction is repeatedly received is about 38% of the electricity consumption when the external sequential read instruction or the external sequential write instruction is repeatedly received.

In other words, in the memory system 101, the thermal throttling processing is not performed when an external random read instruction or an external random write instruction of which heat generation amount is relatively small is repeatedly received. Therefore, a case in which the amount of time required for the reading and writing processing becomes long can be suppressed.

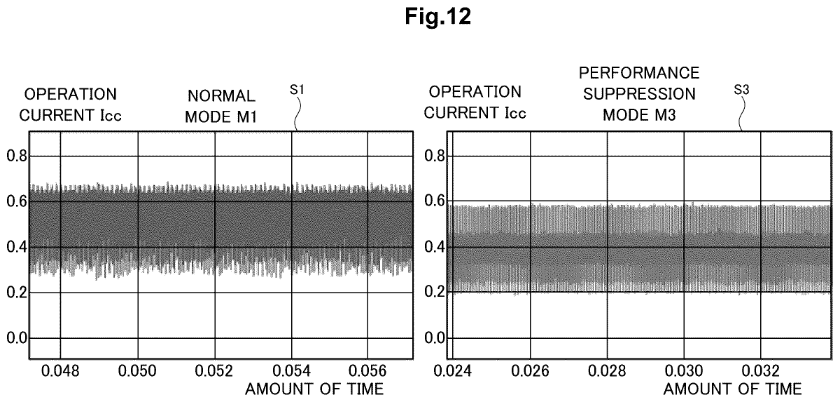

FIG. 12 is a diagram showing one example of a time change of an operation current Icc in a case in which the memory system 101 performs the consecutive sequential read operation.

The vertical axis and the horizontal axis in each of graphs S1 and S3 indicates the operation current Icc and the amount of time, respectively. Graphs S1 and S3 show a time change of the operation current Icc in the normal mode M1 and the performance suppression mode M3, respectively.

Here, the operation current Icc is a measurement result of consumption current in a VCC power supply that supplies electricity to the memory system 101.

As shown in FIG. 12, in the performance suppression mode M3, the performance, in other words, the unit time I/O data amount decreases, and the electricity consumption decreases. Therefore, the operation current Icc in the performance suppression mode M3 is lower than the operation current Icc in the normal mode M1.

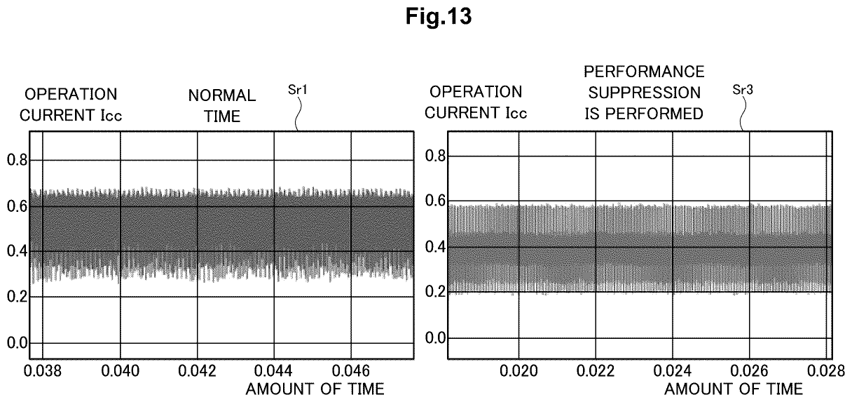

FIG. 13 is a diagram showing one example of a time change of the operation current Icc in a case in which the memory system of the comparative example performs the consecutive sequential read operation.

Graphs Sr1 and Sr3 show a time change of the operation current Icc at normal times and in a case in which the performance suppression is performed, respectively. The way of viewing the graphs Sr1 and Sr3 is similar to that of the graphs S1 and S3.

As shown in FIG. 13, the operation current Icc in a case in which the performance suppression is performed is lower than the operation current Icc at normal times as with the memory system 101 shown in FIG. 12.

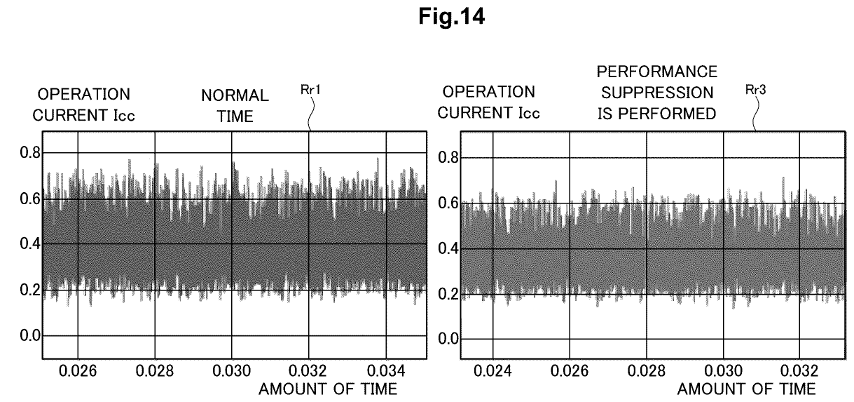

FIG. 14 is a diagram showing one example of a time change of the operation current Icc in a case in which the memory system of the comparative example performs the consecutive random read operation.

Graphs Rr1 and Rr3 show a time change of the operation current Icc at normal times and in a case in which the performance suppression is performed, respectively. The way of viewing the graphs Rr1 and Rr3 is similar to that of the graphs S1 and S3.

As shown in FIG. 14, the operation current Icc in a case in which the performance suppression is performed is lower than the operation current Icc at normal times as with the memory system of the comparative example shown in FIG. 13.

This is because, in the memory system of the comparative example, as described above, the performance suppression is performed regardless of the unit time I/O data amount, and hence a delay amount is provided even for the external random read instruction of which contribution to heat generation is small.

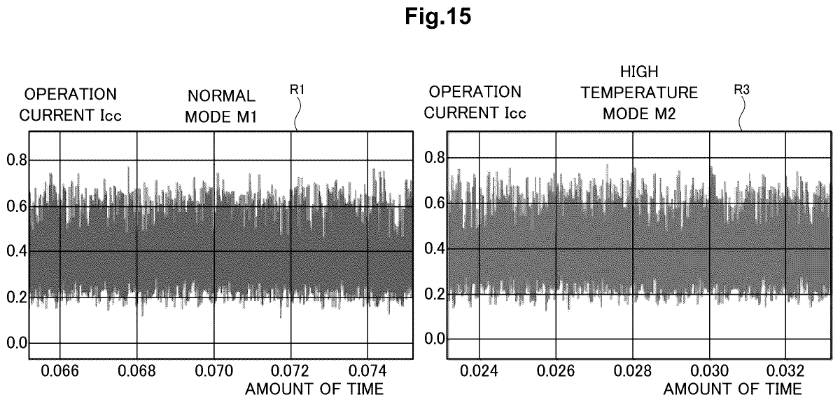

FIG. 15 is a diagram showing one example of a time change of the operation current Icc in a case in which the memory system 101 performs the consecutive random read operation.

Graphs R1 and R3 show a time change of the operation current Icc in the normal mode M1 and the high temperature mode M2, respectively. The way of viewing the graphs R1 and R3 is similar to that of the graphs S1 and S3.

As shown in FIG. 15, when the consecutive random read operation is performed in the memory system 101, the unit time I/O data amount is smaller than the threshold value Dth, and hence the operation mode does not transition to the performance suppression mode M3. Therefore, the electricity consumption in the normal mode M1 and the electricity consumption in the high temperature mode M2 are substantially the same, and hence the operation current Icc in the high temperature mode M2 is substantially the same as the operation current Icc in the normal mode M1.

When the performance suppression mode M3 is set by the operation mode selecting unit 28, the delay circuit control unit 32 may cause the delay circuit 27 to operate once or operate a plurality of times. When the delay circuit 27 is caused to operate a plurality of times, the delay circuit control unit 32 causes the delay circuit 27 to operate for each internal read instruction and each internal write instruction, for example. The delay circuit control unit 32 causes the delay circuit 27 to operate each time the data amount acquisition unit 29 acquires a unit time I/O data amount, for example. Alternatively, the delay circuit control unit 32 causes the delay circuit 27 to operate each time the data amount acquisition unit 29 acquires a unit time I/O data amount a predetermined number of times, for example.

A configuration in which the delay circuit 27 is provided in the memory interface circuit 25 has been described, but the present embodiment is not limited thereto. The delay circuit 27 may be provided in the internal logic unit 21 or the non-volatile memory 10. When the delay circuit 27 is provided in the internal logic unit 21, the delay circuit 27 delays the generation of the internal read instruction and the internal write instruction by the internal logic unit 21 by predetermined delay time, for example. When the delay circuit 27 is provided in the non-volatile memory 10, the delay circuit 27 delays the generation of the internal read instruction and the internal write instruction by the internal logic unit 21 by predetermined delay time, for example.

A configuration in which the temperature Tc being higher than the threshold value Tth is the condition for the transition from the normal mode M1 to the high temperature mode M2 has been described, but the present embodiment is not limited thereto. A configuration in which the temperature Tc being equal to or more than the threshold value Tth is the condition for the transition from the normal mode M1 to the high temperature mode M2 may be employed.

A configuration in which Σ(Data size) being greater than the threshold value Dth in a case in which the temperature Tc is equal to or more than the threshold value Tth is the condition for the transition from the high temperature mode M2 to the performance suppression mode M3 has been described, but the present embodiment is not limited thereto. A configuration in which Σ(Data size) being equal to or more than the threshold value Dth in a case in which the temperature Tc is equal to or more than the threshold value Tth is the condition for the transition from the high temperature mode M2 to the performance suppression mode M3 may be employed.

A configuration in which the temperature Tc being equal to or more than the threshold value Tth and Σ(Data size) being lower than the threshold value Dth is the condition for the transition from the performance suppression mode M3 to the high temperature mode M2 has been described, but the present embodiment is not limited thereto. A configuration in which the temperature Tc being equal to or more than the threshold value Tth and Σ(Data size) being equal to or less than the threshold value Dth is the condition for the transition from the performance suppression mode M3 to the high temperature mode M2 may be employed.

A configuration in which the temperature Tc being lower than the threshold value Tth is the condition for the transition from the performance suppression mode M3 or the high temperature mode M2 to the normal mode M1 has been described, but the present embodiment is not limited thereto. A configuration in which the temperature Tc being equal to or less than the threshold value Tth is the condition for the transition from the performance suppression mode M3 or the high temperature mode M2 to the normal mode M1 may be employed.

A configuration in which the operation mode selecting unit 28 compares the unit time I/O data amount and the threshold value Dth with each other and sets the operation mode to the high temperature mode M2 or the performance suppression mode M3 based on a result of the comparison has been described, but the present embodiment is not limited thereto. A configuration in which the operation mode selecting unit 28 compares the unit time read-out data amount and the threshold value Dth with each other and sets the operation mode to the high temperature mode M2 or the performance suppression mode M3 based on a result of the comparison may be employed. The electricity consumption of the read-out operation of the data in the non-volatile memory 10 is greater than the electricity consumption of the writing operation of the data in the non-volatile memory 10, and hence a sufficient effect can be exhibited even with this configuration. A configuration in which the operation mode selecting unit 28 compares the unit time writing data amount and the threshold value Dth with each other and sets the operation mode to the high temperature mode M2 or the performance suppression mode M3 based on a result of the comparison may be employed.

(a) A storage apparatus, including:
a non-volatile memory having a non-volatile storage region and capable of reading and writing data with respect to the storage region;
a host interface circuit configured to receive, from a host device, external instruction information including an instruction that causes the non-volatile memory to read and write the data;
a memory interface circuit configured to transmit internal instruction information corresponding to the external instruction information to the non-volatile memory; and
a delay circuit configured to delay execution of the instruction by the non-volatile memory when a data amount read and written by the non-volatile memory is equal to or more than a first threshold value during unit time.

(b) A storage apparatus, including:
a non-volatile memory having a non-volatile storage region and capable of reading and writing data with respect to the storage region; and
a host interface circuit configured to receive, from a host device, external instruction information including an instruction that causes the non-volatile memory to read out the data;
a memory interface circuit configured to transmit internal instruction information corresponding to the external instruction information to the non-volatile memory; and
a delay circuit configured to delay execution of the instruction by the non-volatile memory when a data amount read out by the non-volatile memory is equal to or more than a first threshold value during unit time.

(c) A storage apparatus including:
a non-volatile memory having a non-volatile storage region and capable of reading and writing data with respect to the storage region;
a host interface circuit configured to receive, from a host device, external instruction information including an instruction that causes the non-volatile memory to write the data;
a memory interface circuit configured to transmit internal instruction information corresponding to the external instruction information to the non-volatile memory; and
a delay circuit configured to delay execution of the instruction by the non-volatile memory when a data amount written by the non-volatile memory is equal to or more than a first threshold value during unit time.

The present embodiment has been described above with reference to specific examples. However, the present disclosure is not limited to those specific examples. Examples obtained by adding, as appropriate, changes in design to those specific examples by a person skilled in the art are also encompassed in the scope of the present disclosure as long as those examples include the features of the present disclosure. The elements and the arrangement, the condition, the shape, and the like thereof included in each of the specific examples described above are not limited to those exemplified and can be changed, as appropriate. The combination of the elements included in each of the specific examples described above can be changed, as appropriate, as long as there are no technical contradictions.

1. A memory system, comprising:
a non-volatile memory having a non-volatile storage region and capable of reading and writing data with respect to the storage region; and
a controller, wherein the controller includes:
a host interface circuit configured to receive, from a host device, external instruction information including an instruction that causes the non-volatile memory to read and write the data;
a memory interface circuit configured to communicate with the non-volatile memory;
an instruction information processing unit configured to generate internal instruction information for causing the non-volatile memory to execute the instruction based on the external instruction information and configured to transmit the internal instruction information to the non-volatile memory through the memory interface circuit; and
a delay circuit control unit configured to control a delay circuit based on a magnitude relationship between a data amount read and written by the non-volatile memory during unit time and a first threshold value, the delay circuit being configured to delay execution of the instruction.

2. The memory system according to claim 1, wherein the delay circuit control unit is configured to cause the delay circuit to delay the execution of the instruction when the data amount is equal to or more than the first threshold value.

3. The memory system according to claim 2, further comprising a temperature sensor configured to acquire temperature information indicating a temperature of the memory system, wherein the delay circuit control unit is configured to cause the delay circuit to delay the execution of the instruction when the temperature is equal to or more than a second threshold value and the data amount is equal to or more than the first threshold value.

4. The memory system according to claim 1, wherein the delay circuit is configured to delay the execution of the instruction by preventing the internal instruction information from being transmitted to the non-volatile memory during predetermined delay time.

5. The memory system according to claim 2, wherein the delay circuit is configured to delay the execution of the instruction by preventing the internal instruction information from being transmitted to the non-volatile memory during predetermined delay time.

6. The memory system according to claim 3, wherein the delay circuit is configured to delay the execution of the instruction by preventing the internal instruction information from being transmitted to the non-volatile memory during predetermined delay time.

7. The memory system according to claim 1, wherein the first threshold value is smaller than the data amount in a case in which the non-volatile memory reads and writes the data from and to each region having a plurality of consecutive addresses in the storage region and is greater than the data amount in a case in which the non-volatile memory reads and writes the data from and to each region having a plurality of addresses that are not consecutive in the storage region.

8. The memory system according to claim 3, wherein the second threshold value is equal to or less than the temperature when the memory system is continuously operated in a state in which the delay circuit is caused to delay the execution of the instruction in a case in which the non-volatile memory reads and writes the data from and to each region having a plurality of consecutive addresses in the storage region.

9. The memory system according to claim 2, wherein an amount of time from when the host interface circuit receives the external instruction information to when the memory interface circuit transmits the internal instruction information is longer when the delay circuit control unit causes the delay circuit to delay the execution of the instruction as compared to when the delay circuit control unit does not cause the delay circuit to delay the execution of the instruction.

10. The memory system according to claim 1, wherein the host interface circuit complies with the UFS standard.

11. The memory system according to claim 1, wherein the memory interface circuit complies with the ONFI standard.

12. The memory system according to claim 1, wherein the memory interface circuit complies with the Toggle DDR standard.

13. A storage apparatus, comprising:
a non-volatile memory having a non-volatile storage region and capable of reading and writing data with respect to the storage region;
a host interface circuit configured to receive, from a host device, external instruction information including an instruction that causes the non-volatile memory to read and write the data;
a memory interface circuit configured to transmit internal instruction information corresponding to the external instruction information to the non-volatile memory; and
a delay circuit configured to delay execution of the instruction by the non-volatile memory when a data amount read and written by the non-volatile memory is equal to or more than a first threshold value during unit time.

14. A control method in a memory system,
the memory system comprising:
a non-volatile memory having a non-volatile storage region and capable of reading and writing data from and to the storage region; and
a controller configured to communicate with the non-volatile memory,
the control method comprising:
receiving, from a host device, external instruction information including an instruction that causes the non-volatile memory to read and write the data;
generating internal instruction information for causing the non-volatile memory to execute the instruction based on the external instruction information;
transmitting the internal instruction information to the non-volatile memory; and
controlling a delay circuit based on a magnitude relationship between a data amount read and written by the non-volatile memory during unit time and a first threshold value, the delay circuit being configured to delay execution of the instruction.
